(19) United States
(12) Patent Application Publication
(10) Pub. No.: US 2026/0048643 A1
(43) Pub. Date: Feb. 19, 2026

(54) Retractable Vehicular Side Window Sun Visor

(71) Applicants: Zachary Chipperson, Morristown, NJ (US); Rita Chipperson, Morristown, NJ (US)

(72) Inventors: Zachary Chipperson, Morristown, NJ (US); Rita Chipperson, Morristown, NJ (US)

(73) Assignees: Zachary Chipperson, Morristown, NJ (US); Rita Chipperson, Morristown, NJ (US)

(21) Appl. No.: 19/370,164

(22) Filed: Oct. 27, 2025

Related U.S. Application Data
(60) Provisional application No. 63/712,294, filed on Oct. 25, 2024.

(51) Int. Cl. B60J 3/02

(52) U.S. Cl. CPC B60J 3/0208

(57) ABSTRACT

A retractable sun visor is added to a vehicle's integral and primary sun visor. This retractable sun visor is pulled from its housing during use and automatically retracts into the housing when not in use. In another embodiment, an integrated sun visor is mounted internal to the body of the vehicle adjacent to the vehicle's side window. During use, the sun visor is pulled from within the wall of the vehicle for use and then automatically retracted when not in use. In another embodiment, the sun visor includes a housing and a mating clip which are attached to the vehicle adjacent the side window via fasteners and allow the sun visor to be expanded and clipped in place for use and retracted into the housing by unclipping the clips when the visor is not in use.

### CROSS REFERENCE TO RELATED APPLICATIONS

This application is a U.S. non-provisional patent application claiming priority under 35 U.S.C. § 119(e) to U.S. provisional patent application No. 63/712,294, filed Oct. 25, 2024, entitled, “Retractable Vehicular Side Window Sun Visor” which is hereby expressly incorporated by reference as if fully set forth herein.

### COPYRIGHT NOTICE

A portion of the disclosure of this patent document contains material which is or may be subject to copyright protection. The copyright owner has no objection to the facsimile reproduction by anyone of the patent document or the patent disclosure, as it appears in the Patent and Trademark Office patent file or records but otherwise reserves all copyrights whatsoever.

### FIELD

Embodiments of the present invention generally relate to systems and methods for providing a sun visor for a vehicular side window. More specifically, the present invention relates to systems and methods for providing a sun visor for a vehicular side window that is retractable.

### BACKGROUND OF THE INVENTION

Various types of sun visors or shades are known for attaching to a side window. For example, a static cling sun visor includes a lightweight mesh or film that adheres to the window with suction cups. In another example, a retractable roller shade is mounted at the top of the window with suction cups and can be pulled down and rolled back up. In yet another example, a magnetic frame shades includes magnets to attach directly to the metal window frame.

However, these known types of sun visors or shades prevent use of the window, e.g., the window cannot be rolled up and down when the sun visors are positioned on the window. In addition, when positioned on a driver side window or on a front passenger side window, these types of sun visors may inhibit a driver's view of the left side mirror or the right side view mirror, respectively. Thus, there is a need for an improved sun visor for side windows of a vehicle, especially for the driver side window and the passenger front side window.

### BRIEF SUMMARY OF THE INVENTION

In an embodiment, a sun visor for a side window of a front door of a vehicle includes a housing having an attachment mechanism for attaching the sun visor to an integral sun visor of the vehicle. The sun visor includes a shade that is extendable from and retractable into a first end of the housing, wherein the first end of the housing is configured to be positioned towards the side window of the front door of the vehicle when the sun visor is attached to the integral sun visor of the vehicle, wherein the shade includes a first end anchored to the housing and a second end having a clip. The sun visor further includes a mating clip configured for attachment behind the side window of the front door, wherein the mating clip is configured to attach to the clip on the second end of the shade to extend the shade across a top portion of the side window.

In one or more embodiments, the mating clip is configured for attachment to a back side window support in the front door of the vehicle.

In one or more embodiments, a retainer is attached to a front pillar support of the vehicle adjacent to and in front of the front door, wherein the retainer is configured to hold and support the shade when extended across the top portion of the side window.

In one or more embodiments, the first end of the housing forms an aperture, wherein the shade is extendable from and retractable into the aperture.

In one or more embodiments, the clip on the second end of the shade has a greater width than a width of the aperture in the first end of the housing, wherein the clip prevents the second end of the shade from being completely retracted into the housing.

In one or more embodiments, the shade has at least a length to extend from the integral sun visor of the vehicle, across the side window, and to the mating clip attached behind the side window of the vehicle.

In one or more embodiments, the shade has a width to cover the top portion of the side window of the vehicle, wherein the top portion includes a top ½ portion of the side window or less.

In one or more embodiments, the housing includes a constant force spring retractor system for extending and retracting the shade.

In another embodiment, a sun visor for a side window of a front door of a vehicle includes a shade that is extendable from and retractable into a top portion of a side pillar support behind the front door of the vehicle, wherein the shade includes a first end anchored within the side pillar support and a second end having a clip. The sun visor also includes a mating clip attached in front of the side window, wherein the mating clip is configured to attach to the clip on the second end of the shade to extend the shade across a top portion of the side window.

In one or more embodiments, the mating clip is configured for attachment to a side pillar support behind the front door of the vehicle.

In one or more embodiments, the mating clip is configured for attachment to a front pillar support between the front door of the vehicle and a windshield of the vehicle.

In one or more embodiments, the mating clip is configured for attachment to a front side window support in the front door of the vehicle.

In one or more embodiments, the top portion of the side pillar support forms an aperture and wherein the shade is extendable from and retractable into the aperture.

In one or more embodiments, the clip on the second end of the shade has a greater width than a width of the aperture, wherein the clip prevents the second end of the shade from being completely retracted into the aperture.

In one or more embodiments, the shade has at least a length to extend from the side pillar support of the vehicle, across the side window, and to the mating clip attached in front of the side window of the vehicle.

In one or more embodiments, the shade has a width to cover the top portion of the side window of the vehicle, wherein the top portion includes a top ½ portion of the side window or less.

In one or more embodiments, the side pillar support includes a constant force spring retractor system for extending and retracting the shade.

In one or more embodiments, the mating clip is configured for attachment to a top portion of a front windshield of the vehicle.

In one or more embodiments, the mating clip includes an adjustment block that is shaped substantially triangular. The adjustment block includes an upwardly facing side configured for attachment to the top portion of the front windshield of the vehicle, a bottom side, and a second side attached to the mating clip, wherein the second side is positioned substantially parallel with the second end of the shade having the clip when the upwardly facing side is attached to the top portion of the front windshield of the vehicle.

In one or more embodiments, an angle between the upwardly facing side of the adjustment block and the bottom side of the adjustment block is substantially same to an interior, acute angle AW of the front windshield with respect to horizontal and positions the second side of the adjustment block substantially parallel with the second end of the shade having the clip.

In one or more embodiments, an angle between the upwardly facing side of the adjustment block and the bottom side of the adjustment block is adjustable to substantially equal an interior, acute angle AW of the front windshield with respect to horizontal.

In another embodiment, a sun visor for a side window of a front door of a vehicle includes a housing configured for attachment to a top portion of a side pillar support behind the front door of the vehicle. The sun visor further includes a shade that is extendable from and retractable into the housing, wherein the shade includes a first end anchored within the housing and a second end having a clip. The sun visor further includes a mating clip attached in front of the side window, wherein the mating clip is configured to attach to the clip on the second end of the shade to extend the shade across a top portion of the side window.

In one or more embodiments, when the mating clip is attached to the top portion of the front windshield of the vehicle, an angle of the mating clip substantially equals an interior, acute angle AW of the front windshield with respect to horizontal, and the clip on the second end of the shade is at an angle A that is substantially equal to the interior, acute angle AW of the front windshield with respect to horizontal.

In one or more embodiments, a mating clip adjustment block is coupled between the second end of the shade and the clip, wherein the mating clip adjustment block positions the clip at the angle A substantially equal to the interior, acute angle AW of the front windshield with respect to horizontal.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments, which are presently preferred. It should be understood, however, that the invention is not limited to the precise arrangements and instrumentalities shown. In the drawings:

FIG. 1A is an internal front view of a vehicular side window from within a vehicle showing one embodiment of a mating clip and a retainer clip for use with the vehicular sun visor of FIG. 2 in accordance with one embodiment of the present invention;

FIG. 1B is a front view of an integrated vehicular sun visor in accordance with one embodiment of the present invention;

FIG. 2 is a perspective view of a vehicular sun visor of the present invention attached to a vehicle and expanded for use in accordance with one embodiment of the present invention;

FIG. 3A depicts a top view of the vehicle sun visor of FIG. 2 attached to a vehicle's integrated sun visor in accordance with one embodiment of the present invention;

FIG. 3B depicts a left side view of the vehicle sun visor of FIG. 2 attached to a vehicle's integrated sun visor in accordance with one embodiment of the present invention;

FIG. 4A is a front view of a second embodiment of a vehicular sun visor of the present invention installed on a vehicular side in accordance with one embodiment of the present invention;

FIGS. 4B, 4C and 4D alternate embodiments of a mating clip and adjustment blocks for use with the embodiment of the vehicular sun visor in FIG. 4A in accordance with one embodiment of the present invention;

FIGS. 5A and 5B depict two example embodiments of a clip and mating clip for use with the present invention; and

FIG. 6 is a front view of a third embodiment of a vehicular sun visor of the present invention installed on a vehicular side in accordance with one embodiment of the present invention.

### DETAILED DESCRIPTION OF THE INVENTION

Certain terminology may be used in the following description for convenience only and is not limiting. The words “lower” and “upper” and “top” and “bottom” designate directions in the drawings to which reference is made. The terminology includes the words above specifically mentioned, derivatives thereof and words of similar import.

Where a term is provided in the singular, the inventors also contemplate aspects of the invention described by the plural of that term. As used in this specification and in the appended claims, the singular forms “a”, “an” and “the” include plural references unless the context clearly dictates otherwise, e.g., “a strap” may include a plurality of straps. Thus, for example, a reference to “a method” includes one or more methods, and/or steps of the type described herein and/or which will become apparent to those persons skilled in the art upon reading this disclosure.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods, constructs and materials are now described. All publications mentioned herein are incorporated herein by reference in their entirety. Where there are discrepancies in terms and definitions used in references that are incorporated by reference, the terms used in this application shall have the definitions given herein.

In one aspect of the present invention, a secondary add-on sun visor that is an add on to a vehicle's integral and primary sun visor is disclosed. This secondary sun visor includes an internal, retractable sun visor that may be pulled from its housing during use and then automatically retracts into the housing when not in use. In another aspect of the invention, a secondary integrated sun visor is disclosed that is mounted internal to the body of the vehicle adjacent to the vehicle's window. During use, the sun visor is pulled from its position within the wall of the vehicle for use and then is automatically retracted when a user releases it from use.

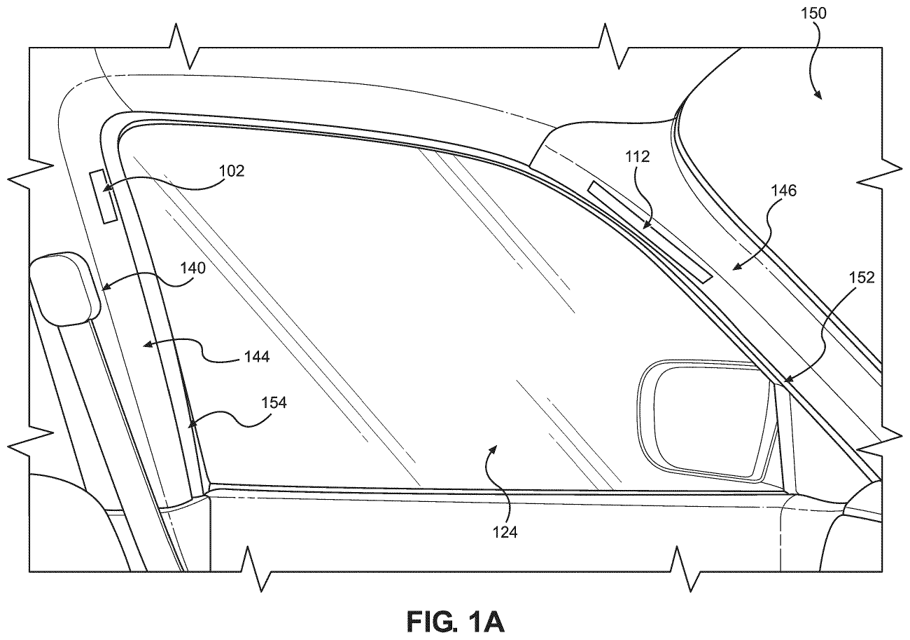

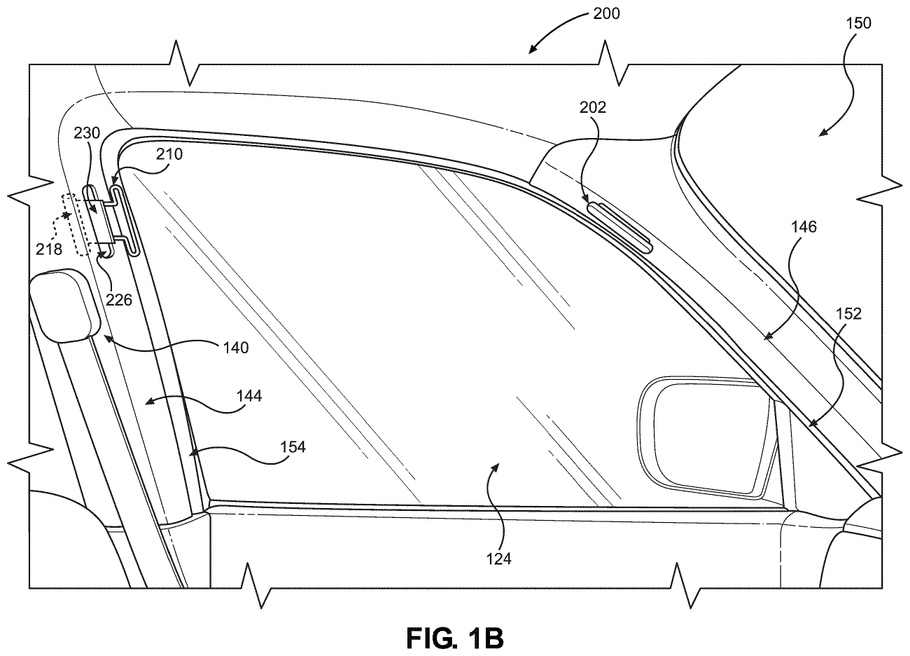

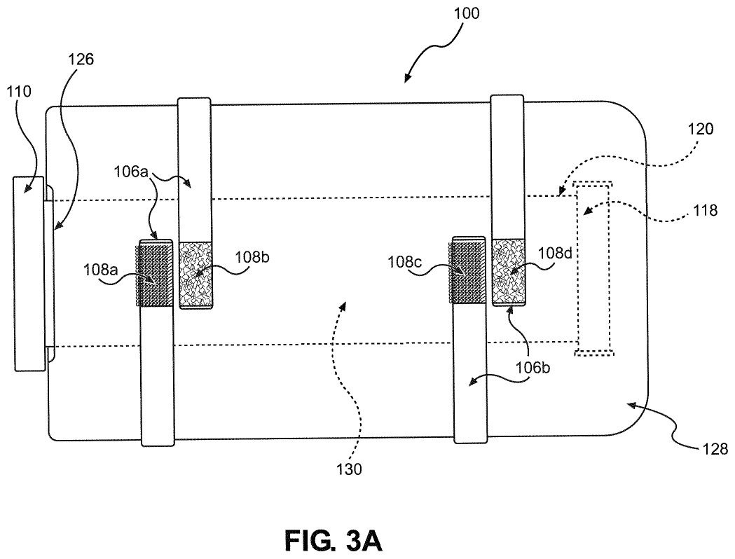

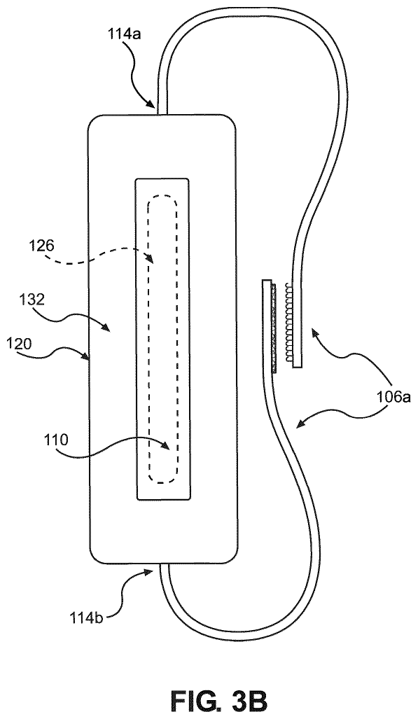

Referring now to FIGS. 1A, 2, and 3, depicted is an add on secondary sun visor 100 in accordance with one embodiment of the present invention. FIG. 3A depicts a top view of sun visor 100 which has a substantially rectangular housing 120 that includes strap pairs 106a and 106b attached thereto. Strap pairs 106a and 106b each have a strap fastener 108a and 108b and 108c and 108d respectively located on an end thereof that allows the two strap pairs to attach to each other. In one embodiment, strap fastener 108a-d is Velcro®, but other fasteners are envisioned without departing from the scope hereof.

Sun visor 100 further includes a retractable sun visor shade 130 internal to the housing 120. A first end of shade 130 is anchored within the housing 120 and attached to a retractor 118 such as, but not limited to, a constant force spring retractor. The shade 130 is wrapped around a roller tube that contains a coiled spring. Pulling the first end of the shade 130 creates tension in the coiled spring and so holds the shade 130 in tension while in its extended position. When the first end of the shade 130 is released, the coiled spring retracts the shade 130 into the housing 120.

A second end of shade 130 is attached to a coupling clip 110. Coupling clip 110 has a width that is greater than the width of aperture 126 in housing 120 through which the shade 130 passes to prevent the clip 110 and the second end of the shade 130 from being completely retracted into housing 120. The aperture 126 is positioned on or near a first end of the housing 120 of the sun visor 100, wherein the first end 132 of the housing 120 is configured to face or be near the side window 124 when the sun visor 100 is installed on the vehicle's integral sun visor 128. The shade 130 is folded or wrapped in a roll within the housing 120 and is extendable from and retractable into the aperture 126 formed in the housing 120.

Clip 110 mates with clip 102, as shown in FIG. 1A. In an embodiment, the clip 110 is positioned on a side pillar support 144 of the vehicle, e.g., behind the front side window 128 and behind the back side window support 154 of the front door of the vehicle. The clip 110 thus does not interfere with opening and closing of the front door or the window 124. The clip 110 is attached to the side pillar support 144 using an adhesive, screw, suction cup, tape, Velcro, or other attachment mechanism. In an embodiment, the clip 110 is positioned wholly or partially above an upper shoulder anchor 140. The upper shoulder anchor 140 attaches to a shoulder portion of a front seat belt. The upper shoulder anchor 140 is often located on the side pillar support 144 of the front side window 124, across from an upper portion of the front seat and near an occupant's shoulder. When the mating clip 110 is attached above or at least partially above the upper shoulder anchor 140, it prevents the shade 130 from contacting or otherwise interfering with the operation of the shoulder portion of the front seat belt.

The shade 130 includes a pliable anti-glare material and/or a pliable, light-reducing material (such as netting or a tinted plastic, such as polycarbonate). The shade 130 may be semi-transparent or translucent material that allows a portion of light to pass through. Alternatively, the shade 130 may be an opaque material that completely blocks light. The shade 130 has at least a length to extend from the integral sun visor 128 of the vehicle, across the side window 124, and to the mating clip 110 attached behind the side window 124 of the vehicle. The shade 130 has a width to cover an upper or top portion of the side window 124, e.g., such as a top half (½) portion of the side window, a top one third (⅓) portion of the side window, a top one fourth (¼) portion of the side window or less.

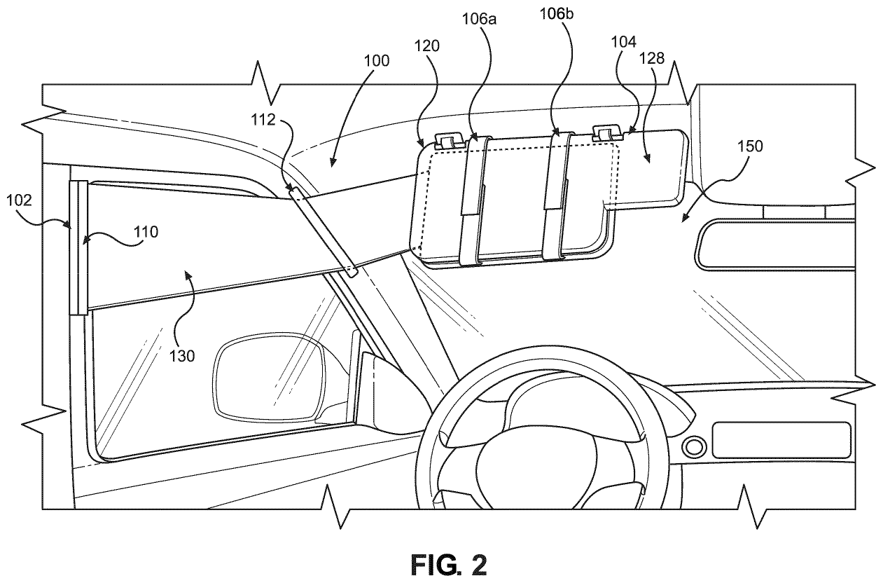

Sun visor 100 may also optionally include a retainer 112 as also shown in FIG. 1A, attached to a front pillar support 146 of the vehicle, e.g., between a front side window support 152 of the front door and the windshield 150. The retainer 112 is mounted to the front pillar support 146 using an adhesive, tape, screw, suction cup, Velcro, or other attachment mechanism. When shade 130 is in use, as shown in FIG. 2, it may be slid under an open bottom end of retainer 112 to allow retainer 112 to hold the shade 130 proximal to the side window 124. However, use of retainer 112 is optional and is not required to implement the systems and methods of the present invention.

The position of the clip 102 on the side pillar support 144 and the optional positioning of the retainer 112 on the front pillar support 146 allows for the continued use of the side window 124 and the front door. For example, when the shade 130 is slid under the retainer 112 and attached to the clip 102, it stretches across the side window 124 and the front door such that the side window 124 may be opened and closed and the front door may also be opened and closed. This positioning of the shade 130 thus allows continued use of the side window 124 and the front door of the vehicle without having to remove or unclip the shade 130. The shade 130 thus allows a passenger to exit the vehicle or open the side window 124 easily, e.g., in case of emergency. Other shades that attach to the side window 124 may prevent opening of the window in case of emergency. In addition, the positioning of the shade 130 on only an upper or top portion of the side window 124 does not block or shade a driver's view of the external side view mirror.

FIG. 3B is a left side view of sun visor 100 showing coupling clip 110 and aperture 126 (in dashed view as it is hidden behind clip 110). The aperture 126 on the side 132 is configured to face or be near the side window 124 when the sun visor 100 is attached to the integral sun visor 128 of the vehicle. FIG. 3B also shows the attachments 114a-b of strap pair 106a to housing 120. In an embodiment, each of the attachments 114a-b may include a slit in the housing 120 wherein a first portion of a strap in the strap pair 106a is threaded through the slit and is anchored inside the housing 120. In another embodiment, each of the attachments 114a-b includes a screw, adhesive, tape, clip, or other attachment means to secure the strap pair 106a to the housing 120.

The operation of sun visor 100 is best understood in FIG. 2. The housing 120 is placed adjacent to the windshield facing side of the vehicle's integral sun visor 128. Strap pairs 106 are wrapped around the integral sun visor 128 to couple the add on visor 100 thereto. When a user wishes to use the add on sun visor 100, he or she pulls clip 110 to the left of housing 120, thereby pulling the sun shade 130 from the housing 120. Clip 110 is attached to a mating clip 102, which causes the sun shade 130 to be suspended in front of the top section of window 124, thereby shading the driver from the sun hitting the side of the vehicle. Optionally, prior to clipping clip 110 to clip 102, the user may insert sun shade 130 under retainer 112 to position the sun shade 130 closer to the window. The sun shade 130 is lightweight and pliable but is held taught and does not droop due to the force exerted on the body 130 by retractor 118. When a user no longer needs the side shade 100, the user unclips clip 110 from mating clip 102, optionally removes the sun shade 130 from underneath retainer 112, and allows the sun shade 130 to retract into housing 120.

Though strap pairs 106a-b are disclosed as attaching the sun visor 100 to the vehicle's integral sun visor 128, other attachment mechanisms may be employed to attach the sun visor 100 to the vehicle's integral sun visor 128. For example, in an embodiment, one or more clips on a top portion of the sun visor 100 and/or one or more clips on a bottom portion of the sun visor 100 are used to clip and attach the sun visor 100 to the vehicle's integral sun visor 128.

In another embodiment, the clip 102 is attached to an upper back portion of the side window 124, using a suction cup, adhesive, tape, Velcro, etc. In yet another embodiment, the clip is attached to an upper portion of the back side window support 154 of the front door of the vehicle, using a suction cup, adhesive, tape, Velcro, etc.

As seen in FIG. 1B, in an alternate embodiment, secondary integrated sun visor 200 is disclosed that is mounted internal to the body of the vehicle adjacent to the vehicle's window in accordance with one embodiment of the present invention. The sun visor 200 does not require a housing because in this embodiment, the sun shade 200 is enclosed within the side pillar support 144 of the front side window 124, which acts as a housing. Sun visor 200 includes a retractable sun visor shade 230. A first end of shade 230 is attached to a retractor 218 such as, but not limited to, a constant force spring retractor, which is mounted inside the side pillar support 144 of the vehicle above or at least partially above the upper shoulder anchor 140. A second end of shade 230 is attached to a coupling clip 210. Coupling clip 210 has a width that is greater than the width of aperture 226 through which the shade 230 passes in order to avoid the shade 230 from being completely retracted into the side pillar support 144 of the vehicle. Coupling clip 210 mates with clip 202, which is mounted to the front pillar support 146 using an adhesive, tape, screw, Velcro, suction cup, or other attachment mechanism.

During operation of sun visor 200, when a user wishes to use the secondary sun visor 200, he or she pulls clip 210 to the right, thereby pulling the shade 230 from the inside of the side pillar support 144. Clip 210 is then attached to the mating clip 202, which causes the shade 230 to be suspended in front of the top section of the side window 124, thereby shading the driver from the sun hitting the side of the vehicle. The shade 230 is lightweight and pliable but is held taught and does not droop due to the force exerted on the shade 230 by retractor 218. When a user no longer needs the shade 230, the user unclips clip 210 from mating clip 202 and allows the shade 230 to retract into the side pillar support 144. Similar to the embodiment in FIG. 1A, the positioning of this embodiment of the sun visor 200 also allows continued use of the side window 124 and the door of the vehicle without having to remove or unclip the shade 230. The sun visor 200 also does not impede the use of the shoulder portion of the seat belt.

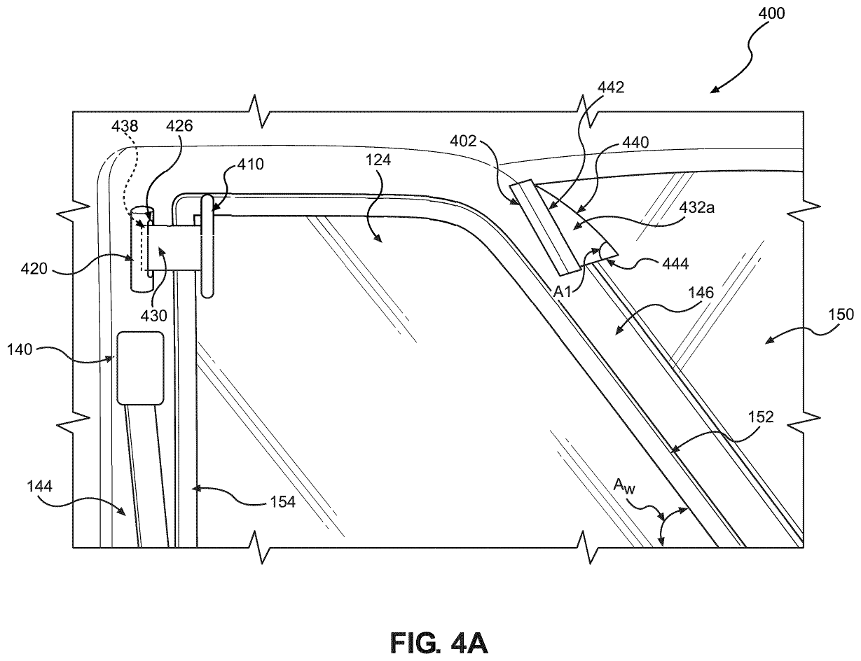

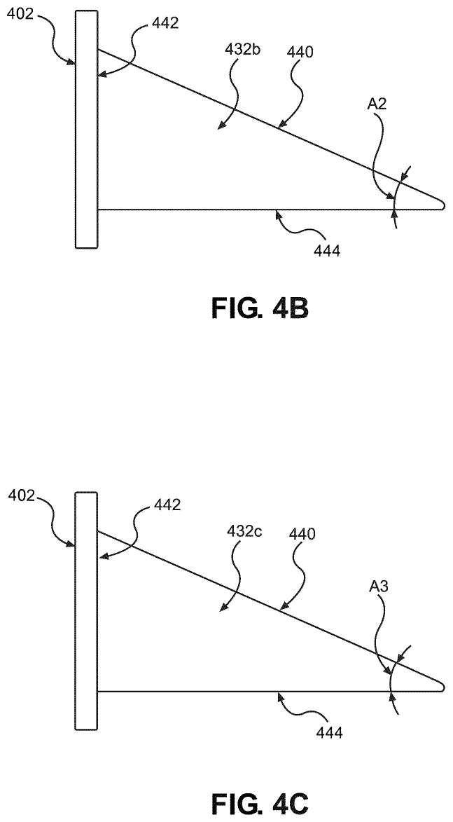

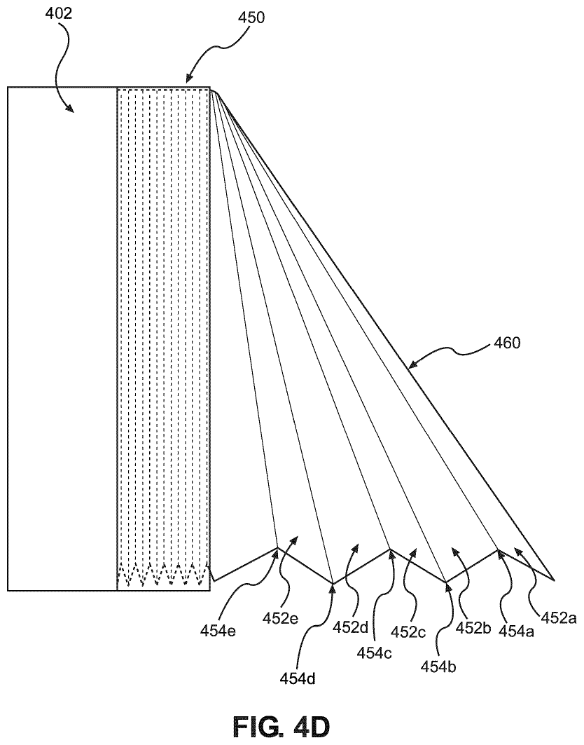

Turning now to FIG. 4A, depicted is a second embodiment of an add on secondary sun visor 400 that includes a shade housing 420 having an internal retractor 438 coupled to one end of a shade 430 and clip 410, mating clip 4zsa02, and mating clip adjustment block 432a in accordance with one embodiment of the present invention. The shade housing 420 is a substantially cylindrical housing that attaches to the side pillar support 144 via a housing fastener such as an adhesive, Velcro, screws, tape, suction cup, or other attachment mechanism. In FIG. 4A, the shade housing 420 houses the majority of shade 430 when it is not in use. That is, a first end of shade 430 is attached to a retractor 438 such as, but not limited to, a constant force spring retractor that coils the shade 430 around the spring-loaded retractor whenever the shade 430 is not in use (i.e., when clip 410 is not mated to mating clip 402). The second end of shade 430 is attached to a coupling clip 410. Coupling clip 410 has a width that is greater than the width of aperture 426 of housing 438 through which the shade 430 passes in order to avoid the shade from being completely retracted into housing 438.

Clip 410 mates with mating clip 402 when the shade 430 is in use. In the depicted embodiment, mating clip 402 includes a mating clip adjustment block 432a attached to its rear side. In the depicted embodiment, mating clip adjustment block 432a is substantially triangular with an angle A1 between an upwardly facing side 440 and a lower side 444 of approximately 45 degrees, however, alternative adjustment blocks 432 with different angles are also envisioned such as the adjustment blocks 432b and 432c shown in FIGS. 4B and 4C having angles of A2=30 degrees and A3=60 degrees, respectively.

The front face 406 of adjustment block 432 is coupled to mating clip 402 to hold clip 402 in a substantially vertical position and/or in a position substantially parallel to the clip 410 such that clip 402 may be coupled easily to clip 410 when the sun visor 400 is in use. For example, when the angled, upwardly facing side 440 of adjustment block 432 is attached to a top portion of the front windshield, the upwardly angled side 440 of the adjustment block 432 is angled to approximate the interior, acute angle Aw of the front windshield 150 with respect to horizontal. Thus, the front side 442 of the attachment block 432 that is attached to the clip 402 is substantially parallel (e.g., parallel to within 15 degrees or less) to mating clip 410. When purchasing the sun visor 100, a user selects the adjustment block 432 with the angle A1, A2, A3 that best approximates the interior, acute angle Aw of the user's front windshield 150 with respect to horizontal. For example, the angle A1, A2, A3 of the adjustment block is selected to be substantially the same acute angle Aw as the front windshield of the vehicle, e.g., within 15 degrees or less. Blocks 432a-c may be made of a hard material such as plastic or may be fabricated from a foam type material that allows the upwardly facing surface 440 of block 432 to be formed to the surface of the vehicle's window front windshield 150 as needed.

In use, the upwardly facing surface 440 of adjustment block 432 is coupled to the vehicle's front windshield 150 using a block fastener such as adhesive, tape, Velcro, suction cups, or the like. The sun visor 400 is mounted to the vehicle's side pillar support 144 or in another embodiment, to a back side window support 154 of the front door of the vehicle. The mating clip 402 and its associated block 432 is mounted on a top portion of the front windshield 150 on a side of the front windshield 150 that is adjacent to the side window 124, e.g., using any acceptable fastener as described herein.

When a user wishes to use the add on sun visor 400, he or she pulls clip 410 to the right of housing 420, thereby pulling the shade 430 from the housing 420. Clip 410 is then attached to the mating clip 402, which causes the shade 430 to be suspended in front of the top section of the side window 124, thereby shading the driver from the sun hitting the side window 124 of the vehicle. The sun shade 430 is lightweight and pliable but is held taught and does not droop due to the force exerted on the shade 430 by retractor 438. When a user no longer needs the shade 430, the user unclips clip 410 from mating clip 402 and allows the shade 430 to automatically retract into housing 420 under the spring force of the retractor 438.

FIG. 4D illustrates another embodiment of a mating clip 402 with an adjustment block 432d that adjusts to different angles. In one embodiment, the adjustment block 432d includes a housing 450 with a plurality of stacked triangular panels 452 coupled by locking hinges 454 that expand in accordion-style steps. For example, a left side of a first triangular panel 452a is attached to a right side of a second triangular panel 452b. The left side of the second triangular panel 452b is attached to the right side of a third triangular panel 452c, etc. The sides 452a-e are attached by lockable hinges 454a-e that lock when expanded. In use, the front side 460 of the first triangular panel 452a is attached to a front windshield 150 of the vehicle. The triangular panels 452 are expanded and locked into place until the mating clip 402 aligns, e.g., the mating clip 402 is substantially parallel with the clip 410 of the shade 430. For example, the angle formed by extended triangular panels 452 is substantially equal to the interior, acute angle Aw of the front windshield with respect to horizontal. This embodiment in FIG. 4D is only one example of an expandable adjustment block 432 that adjusts to different angles and other embodiments may be implemented herein.

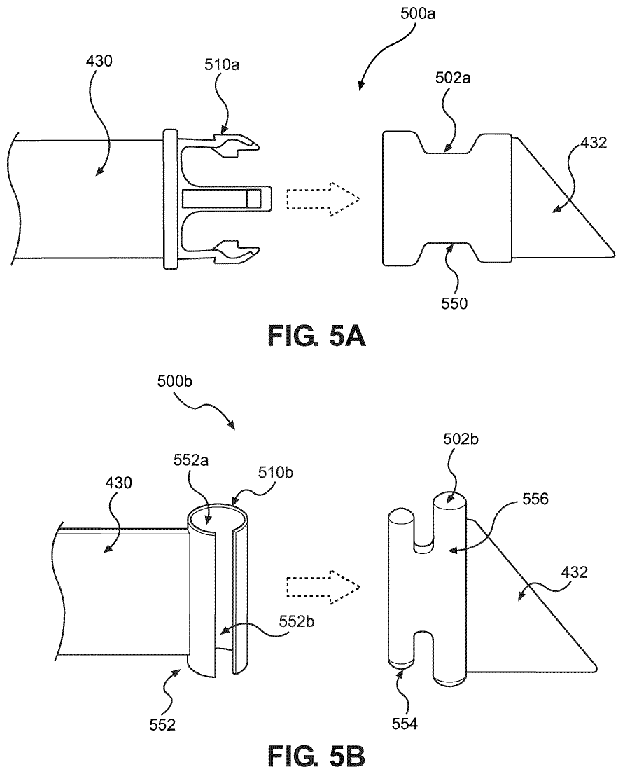

Two examples of clips and mating clips are shown in FIGS. 5A and 5B. In FIG. 5A, a latch style clip 500a is depicted in which the female latch 510a is inserted into a mating male latch 502a and clicks into place. To remove latch 510a from latch 502a, the user squeezes the latch 502a at its indentations 550, thereby releasing latch 510a from 502a and allowing the shade coupled to latch 510a to be recoiled into its housing. In FIG. 5B, a sliding style clip 500b is depicted in which the female latch 510b is substantially cylindrical with a notch 552 cut longitudinally through the center (552a) and a longitudinal portion of an exterior surface thereof (552b). Mating clip 502b is in the form of base 556 coupled to a pin 554 that is slightly smaller than the notch 552 of latch 510b. To couple 510b to 502b, a user slides pin 554 through the notch 552a from either the top or bottom end. The width of notch portion 552b is less than the width of the pin 554, thereby preventing clip 510b from disengaging from 502b unless or until the pin is removed vertically from notch 553. To remove clip 510b from mating clip 502b, the user slides the pin 554 vertically until it is fully removed from notch 552, thereby releasing clip 510b from clip 502b and allowing the shade coupled to latch 510b to be recoiled into its housing. Either type of clip 500a, 500b may be implemented as the clip and mating clip described herein.

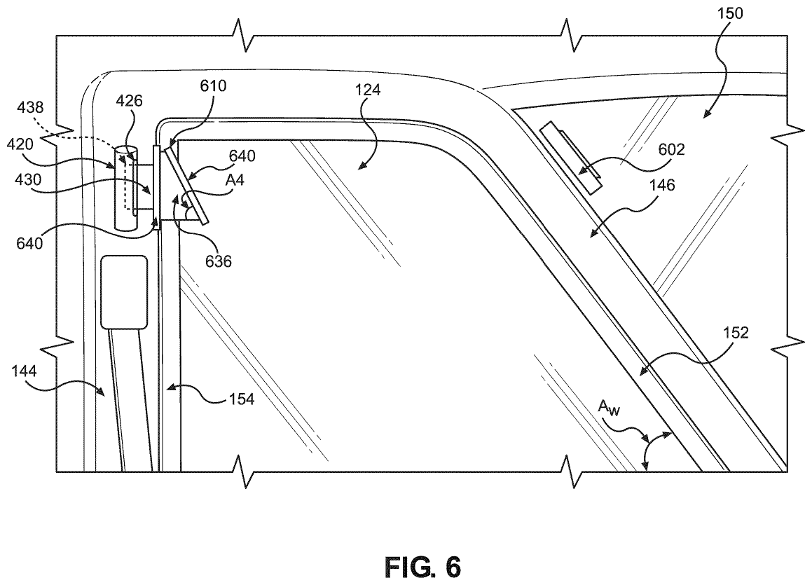

Turning now to FIG. 6, a third embodiment of an add on secondary sun visor 600 is shown. Sun visor 600 is identical to sun visor 400 with the exception that the clip 602 does not have a mating clip adjustment block 432a. Rather, an upwardly facing surface 604 of the mating clip 602 is mounted on a front windshield 150 at the angle of the front windshield. Alternatively, a side facing surface 606 of the mating clip 602 is mounted on the side window 124 at an angle that approximates that of a front portion of the vehicle's side window 124. Clip 610 includes a mating clip adjustment block 636 that causes clip 610 to be located at an angle that substantially matches that of mating clip 602. In the depicted embodiment, the end of shade 430 includes a substantially vertical and substantially cylindrical or rectangular stop 640 at the end of the shade 430 opposite the retractor 438, whose function is to prevent the shade 430 from fully retracting into housing 420.

The mating clip adjustment block 636 is coupled to the side of stop 640 that is opposite shade 430. Clip 610 is coupled to the upwardly facing surface 640 of block 636 to position it properly for mating with mating clip 602. The angle A4 of the upwardly facing surface 640 of block 636 is configured to be substantially equal to the interior, acute angle Aw of the front windshield 150. The mating clip adjustment block 636 thus positions the clip at the angle A4 substantially equal to the interior, acute angle AW of the front windshield with respect to horizontal. The angle A4 can be varied as needed depending on the make and model of the vehicle and its corresponding side window configuration and/or front windshield. In the depicted embodiment, angle A4 is approximately 45 degrees but other angles may be substituted without departing from the scope hereof.

The sun visor described herein can be configured for a driver side window or the passenger side window. When installed on the passenger side window, the positioning of the shade 130 on an upper portion of the passenger side window does not block or shade a driver's view of the external side view mirror on the right passenger side of the vehicle. When installed on the driver side window, the positioning of the shade 130 on an upper portion of the driver side window does not block or shade a driver's view of the external side view mirror on the left driver side of the vehicle.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A sun visor for a side window of a front door of a vehicle, comprising:
a housing having an attachment mechanism for attaching the sun visor to an integral sun visor of the vehicle;
a shade that is extendable from and retractable into a first end of the housing, wherein the first end of the housing is configured to be positioned towards the side window of the front door of the vehicle when the sun visor is attached to the integral sun visor of the vehicle, wherein the shade includes a first end anchored to the housing and a second end having a clip; and
a mating clip configured for attachment behind the side window of the front door, wherein the mating clip is configured to attach to the clip on the second end of the shade to extend the shade across a top portion of the side window.

2. The sun visor of claim 1, wherein the mating clip is configured for attachment to a side pillar support behind the front door of the vehicle.

3. The sun visor of claim 1, wherein the mating clip is configured for attachment to a back side window support in the front door of the vehicle.

4. The sun visor of claim 1, further comprising:
a retainer attached to a front pillar support of the vehicle adjacent to and in front of the front door, wherein the retainer is configured to hold and support the shade when extended across the top portion of the side window.

5. The sun visor of claim 1, wherein the first end of the housing forms an aperture, wherein the shade is extendable from and retractable into the aperture.

6. The sun visor of claim 5, wherein the clip on the second end of the shade has a greater width than a width of the aperture in the first end of the housing, wherein the clip prevents the second end of the shade from being completely retracted into the housing.

7. The sun visor of claim 1, wherein the shade has at least a length to extend from the integral sun visor of the vehicle, across the side window, and to the mating clip attached behind the side window of the vehicle.

8. The sun visor of claim 1, wherein the shade has a width to cover the top portion of the side window of the vehicle, wherein the top portion includes a top ½ portion of the side window or less.

9. The sun visor of claim 1, wherein the housing includes a constant force spring retractor system for extending and retracting the shade.

10. A sun visor for a side window of a front door of a vehicle, comprising:
a shade that is extendable from and retractable into a top portion of a side pillar support behind the front door of the vehicle, wherein the shade includes a first end anchored within the side pillar support and a second end having a clip; and
a mating clip attached in front of the side window, wherein the mating clip is configured to attach to the clip on the second end of the shade to extend the shade across a top portion of the side window.

11. The sun visor of claim 10, wherein the mating clip is configured for attachment to a front pillar support between the front door of the vehicle and a windshield of the vehicle.

12. The sun visor of claim 10, wherein the mating clip is configured for attachment to a front side window support in the front door of the vehicle.

13. The sun visor of claim 10, wherein the top portion of the side pillar support forms an aperture and wherein the shade is extendable from and retractable into the aperture.

14. The sun visor of claim 13, wherein the clip on the second end of the shade has a greater width than a width of the aperture, wherein the clip prevents the second end of the shade from being completely retracted into the aperture.

15. The sun visor of claim 10, wherein the shade has at least a length to extend from the side pillar support of the vehicle, across the side window, and to the mating clip attached in front of the side window of the vehicle.

16. The sun visor of claim 10, wherein the shade has a width to cover the top portion of the side window of the vehicle, wherein the top portion includes a top ½ portion of the side window or less.

17. The sun visor of claim 10, wherein the side pillar support includes a constant force spring retractor system for extending and retracting the shade.

18. The sun visor of claim 10, wherein the mating clip is configured for attachment to a top portion of a front windshield of the vehicle.

19. The sun visor of claim 18, wherein the mating clip comprises:
an adjustment block that is shaped substantially triangular, wherein the adjustment block includes:
an upwardly facing side configured for attachment to the top portion of the front windshield of the vehicle;
a bottom side; and
a second side attached to the mating clip, wherein the second side is positioned substantially parallel with the second end of the shade having the clip when the upwardly facing side is attached to the top portion of the front windshield of the vehicle.

20. The sun visor of claim 19, wherein an angle between the upwardly facing side of the adjustment block and the bottom side of the adjustment block is substantially same to an interior, acute angle Aw of the front windshield with respect to horizontal and positions the second side of the adjustment block substantially parallel with the second end of the shade having the clip.

21. The sun visor of claim 19, wherein an angle between the upwardly facing side of the adjustment block and the bottom side of the adjustment block is adjustable to substantially equal an interior, acute angle Aw of the front windshield with respect to horizontal.

22. The sun visor of claim 19, wherein when the mating clip is attached to the top portion of the front windshield of the vehicle, an angle of the mating clip substantially equals an interior, acute angle Aw of the front windshield with respect to horizontal; and
wherein the clip on the second end of the shade is at an angle A that is substantially equal to the interior, acute angle Aw of the front windshield with respect to horizontal.

23. The sun visor of claim 22, further comprising:
a mating clip adjustment block coupled between the second end of the shade and the clip, wherein the mating clip adjustment block positions the clip at the angle A substantially equal to the interior, acute angle Aw of the front windshield with respect to horizontal.

24. A sun visor for a side window of a front door of a vehicle, comprising:
a housing configured for attachment to a top portion of a side pillar support behind the front door of the vehicle;
a shade that is extendable from and retractable into the housing, wherein the shade includes a first end anchored within the housing and a second end having a clip; and
a mating clip attached in front of the side window, wherein the mating clip is configured to attach to the clip on the second end of the shade to extend the shade across a top portion of the side window.

25. The sun visor of claim 24, wherein the housing forms an aperture and wherein the shade is extendable from and retractable into the aperture.

26. The sun visor of claim 24, wherein the mating clip is configured for attachment to a top portion of a front windshield of the vehicle.

27. The sun visor of claim 26, wherein when the mating clip is attached to the top portion of the front windshield of the vehicle, an angle of the mating clip substantially equals an interior, acute angle Aw of the front windshield with respect to horizontal; and
wherein the clip on the second end of the shade is at an angle A that is substantially equal to the interior, acute angle Aw of the front windshield with respect to horizontal.

28. The sun visor of claim 27, further comprising:
a mating clip adjustment block coupled between the second end of the shade and the clip, wherein the mating clip adjustment block positions the clip at the angle A substantially equal to the interior, acute angle Aw of the front windshield with respect to horizontal.
